(19) United States
(12) Patent Application Publication
(10) Pub. No.: US 2026/0235295 A1
(43) Pub. Date: Aug. 13, 2026

(54) Control Knob Method and Apparatus For Cooking Appliance

(71) Applicant: Midea Group Co., Ltd., Foshan (CN)

(72) Inventors: Antonio Lopez Juarez, Louisville, KY (US); Felix Conde Zelocuatecatl, Louisville, KY (US)

(73) Assignee: Midea Group Co., Ltd., Foshan (CN)

(21) Appl. No.: 19/051,924

(22) Filed: Feb. 12, 2025

(51) Int. Cl. F24C 7/08; F24C 3/12; G01D 5/14; H01H 19/14

(52) U.S. Cl. CPC F24C 7/085; F24C 3/122; G01D 5/145; H01H 19/14

(57) ABSTRACT

A method and apparatus of a control knob for a cooking appliance. The control knob includes a safety feature or initiation step for operating one or more cooking elements of the cooking appliance.

### BACKGROUND OF THE INVENTION

In appliance manufacturing industries generally, and specifically in the range or cooking appliance manufacturing industries, most appliances such as cooktops or ranges have a variety of control or selector knobs for adjusting and controlling the amount of heat supplied to the various appliance burners or heating elements. Typically, these knobs are easily accessible to the average user, thereby making them simple and quick to operate, but also providing ready access to children and others lacking the requisite judgment to safely operate the appliance.

In order to provide a measure of safety to oven and cooktop appliances, manufacturers have equipped some control knobs and selectors with simple lockout mechanisms. For example, some control knobs are mounted on spring-loaded shafts that require a user to push or depress the knob slightly before it will turn (e.g. push and turn, two-step activation), thereby providing at least a small measure of child-safety lockout protection. Gas appliances are typically equipped with these push-unlock valves as a lockout mechanism to prevent accidental valve operation.

Household cooking gas appliances in the United States are certified to the ANSI Z21.1 standard. This standard states that “Any manual gas valve or energy controlling device intended for use during normal operation and that has an off position to shut off the gas to a main burner or the energy flow to a heating/cooking element shall necessitate not less than two separate manual operations to turn on and shall necessitate only one manual operation to turn off.” Typically, many standard manual gas valves are made to open from the closed position by first pushing in and then turning (e.g. push and turn along the rotational/longitudinal axis), for example. Further, appliances may utilize “digital” gas valves wherein a control knob is connected or secured to an electrical component, for example a resolver or encoder, that then translates the rotational position of the valve into an electrical signal representative of desired valve positioned to an electrically actuated gas valve to control the burner. In the case of these digital valves may be made to open from the closed position by first pushing in and then turning (e.g. push and turn, two-step/manual operations), for example, in order to provide safe operation of the valves and concomitant burners.

Various child lockout systems have been provided in the industry, with varying degrees of safety and operability. There does not exist, however, a reliable system for providing child safety control to an appliance that simultaneously provides ease of access and use for an adult user.

From the foregoing it can readily be seen that there is a need in the art for a control/actuator system (e.g. valve, gas valve, digital valve, electric, gas, both gas and electric) that utilizes an initiation process, for example an initiation process and concomitant knob or actuator that can be employed with individual appliances to control the heating/cooking elements (e.g. electric, gas, both) of the appliance.

### SUMMARY OF THE INVENTION

In some embodiments, a cooking appliance may include one or more cooking elements. In various embodiments, the appliance may include a control knob operating the one or more cooking elements and having one or more first portions moveable relative to a second portion of the control knob between a first configuration and a second configuration different from the first configuration. In some embodiments, the one or more first portions may include one or more magnets. In various embodiments, the appliance may include an electronic board having one or more Hall-sensors. In some embodiments, the appliance may include a controller in communication with one or more Hall-sensors. In some embodiments, the one or more Hall-sensors may be configured to output a first output when in the first configuration and a second output when in the second configuration different from the first output. In various embodiments, when the controller receives the first output when the one or more first portions with the one or magnets are in the first configuration the controller may be configured to not allow activation of the one or more cooking elements. In some embodiments, when the controller receives the second output when the one or more first portions with the one or more magnets are in the second configuration the controller may be configured to allow activation of the one or more cooking elements.

In addition, in some embodiments, the controller receiving the first output may send an alarm or alert corresponding to not allowing activation of the one or more cooking elements. In various embodiments, the control knob may include an output representation of a desired energy flow to the one or more cooking elements. In some embodiments, the second output may be within a predetermined range of voltage change. In various embodiments, the control knob may include a home position, and wherein the second output may occur only in the home position of the control knob. In various embodiments, the one or more first portions of the control knob may include opposing biased members. In some embodiments, each one of the opposing biased members may include at least one of the one or more magnets.

In some embodiments, a system for initiation of activation of one or more cooking elements comprising a burner control selector having an output representation of energy flow to the one or more cooking elements. In various embodiments, the system may include a first portion of at least one control knob having one or more magnets moveable relative to a second portion of at least one control knob. In some embodiments, the system may include an electronic board having one or more Hall-sensors, the one or more Hall-sensors having an output representative of a permission to activate the burner control selector. In some embodiments, the system may include a controller having a plurality of inputs and outputs for receiving and providing electrical signals. In various embodiments, the system may include a first input operatively coupled to the output of the one or more Hall-sensors representative of a first configuration of the one or more magnets of the first portion of at least one control knob and wherein no permission to operate the one or more cooking elements receiving the output of the burner control selector. In some embodiments, the system may include a second input operatively coupled to the output of the one or more Hall-sensors representative of a second configuration of the one or more magnets of the first portion of at least one control knob wherein the one or more cooking elements is operated only after receiving the output of the burner control selector.

In addition, in some embodiments, the second input must be received by the controller when at least one control knob is in single rotational position. In various embodiments, the one or more cooking elements may be at least one of electric and/or gas. In some embodiments, the output of the burner control selector may be a two-step activation of the one or more cooking elements. In various embodiments, the output of the burner control selector may be a single-step activation of the one or more cooking elements. In some embodiments, the system may include a first output representative of the first configuration of the one or more magnets of the first portion of at least one control knob wherein an alert is presented when no permission to operate the one or more cooking elements receiving the output of the burner control selector. In various embodiments, the first portion of at least one control knob may include two opposing biased members.

In some embodiments, a method for controlling operation of one or more cooking elements with a safety feature of a control knob, the method may include providing at least one control knob operably connected to one or more cooking elements of a cooking appliance. In various embodiments, at least one control knob may include a first portion having one or more magnets and a second portion. In some embodiments, the method may include providing one or more Hall-sensors adjacent at least one control knob. In some embodiments, the one or more Hall-sensors may output a voltage received by a controller. In various embodiments, the method may include displacement of the first portion of at least one control knob having the one or more magnets relative to both the one or more Hall-sensors and the second portion creates a first output voltage. In some embodiments, the method may include activating the one or more cooking elements when the first output voltage received by the controller is within a predetermined range and not activating the one or more cooking elements when the first output voltage received by the controller is outside the predetermined range.

In addition, in some embodiments, the method may include alerting the user that the one or more cooking elements cannot be activated or when the first output voltage received by the controller is outside the predetermined range. In various embodiments, a burner control selector may have an output representative of an energy flow to the one or more cooking elements. In some embodiments, the burner control selector may include a two-step activation or a single-step activation. In various embodiments, the burner control selector may be inoperable when the first output voltage received by the controller is outside the predetermined range. In some embodiments, the step of activating the one or more cooking elements may include operation of the burner control selector only after the first output voltage received by the controller is within the predetermined range. In various embodiments, the one or more cooking elements may be at least one of gas and/or electric.

The present disclosure is related to systems and apparatus for providing at least two step turn on operation for a digital gas valve control for an appliance. The system described herein utilizes a knob or selector assembly mounted in the appliance that may be selectively touched and rotated. In some aspects and embodiments the system described may include a knob or selector assembly that may be pressed and/or rotated.

In various embodiments, the system disclosed herein provides at least a two-step configurable knob control that, when activated, provides a user defined operation to at least one control knob to operate an appliance gas valve to an open position and/or energize an electric/gas burner. In other aspects and embodiments a knob or selector may include at least one selector button, portion, or switch may be provided for one step of the at least two-step process to actuate a valve. In other aspects and embodiments a knob or selector may include at least one selector button, portion, or switch may be provided for one step of a three-step process to actuate a valve.

In various aspects and embodiments the system described herein may include a processor having a plurality of inputs and outputs that are operatively coupled to various components of an appliance, including a control knob pushbutton, switch or Hall-sensor.

As used herein for purposes of the present disclosure, the term “appliance” should be understood to be generally synonymous with and include any device that consumes electrical power and can be connected to an electrical circuit or battery, for example one used in a residential or commercial setting to accomplish work. The appliances referred to herein may include a plurality of electrically operated components powered by the circuit, the components operable by manipulation of control knobs or selectors. The appliances referred to herein may also include a gas/power supply or source and/or one or more gas valves for supplying gas/electricity to a burner or heating/cooking element. The appliance gas valves may be controlled by a selector or knob, either directly or indirectly, and the appliance may also include a processor or processors that operate, control and monitor the appliance and the various components and functions thereof referred to throughout this specification.

The terms “knob” or “selector” are used herein generally to describe various devices that are operatively coupled to functional components of the appliance and which may typically, but not exclusively, be operated by hand by a user. Typical control knobs and selectors include but are not limited to gas and electric burner controls, gas and electric oven controls, lighting and timing controls, start and stop controls, switches, sliders, pushbuttons, wheels, levers, and various other functional controls associated with an appliance. “Selector” may also be used to refer to a programmed button selection on a touch-screen or similar operator interface.

The term “controller” or “processor” is used herein generally to describe various apparatus relating to the operation of the system and the appliances referred to herein. A controller can be implemented in numerous ways (e.g., such as with dedicated hardware) to perform various functions discussed herein. A “processor” is one example of a controller which employs one or more microprocessors that may be programmed using software (e.g., microcode) to perform various functions discussed herein. A controller may be implemented with or without employing a processor, and also may be implemented as a combination of dedicated hardware to perform some functions and a processor (e.g., one or more programmed microprocessors and associated circuitry) to perform other functions. Examples of controller components that may be employed in various embodiments of the present disclosure include, but are not limited to, conventional microprocessors, application specific integrated circuits (ASICs), programmable logic controllers (PLCs), and field-programmable gate arrays (FPGAs).

A processor or controller may be associated with one or more storage media (generically referred to herein as “memory,” e.g., volatile and non-volatile computer memory such as RAM, PROM, EPROM, and EEPROM, floppy disks, compact disks, optical disks, magnetic tape, etc.). In some implementations, the storage media may be encoded with one or more programs that, when executed on one or more processors and/or controllers, perform at least some of the functions discussed herein. Various storage media may be fixed within a processor or controller or may be transportable, such that the one or more programs stored thereon can be loaded into a processor or controller so as to implement various aspects of the present disclosure discussed herein. The terms “program” or “computer program” are used herein in a generic sense to refer to any type of computer code (e.g., software or microcode) that can be employed to program one or more processors or controllers.

The term “Internet” or synonymously “Internet of things” refers to the global computer network providing a variety of information and communication facilities, consisting of interconnected networks using standardized communication protocols. The appliances, controllers and processors referred to herein may be operatively connected to the Internet.

It should be appreciated that all combinations of the foregoing concepts and additional concepts discussed in greater detail below (provided such concepts are not mutually inconsistent) are part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF THE DRAWINGS

In the drawings, like reference characters generally refer to the same parts throughout the different views. The drawings are not necessarily to scale. Emphasis is instead generally placed upon illustrating the principles of the disclosure, wherein;

FIG. 1 is a perspective view of a gas appliance having a plurality of control knobs in accordance with various embodiments;

FIG. 2 is a perspective view of a control knob assembly illustrating a first configuration in accordance with various embodiments;

FIG. 3 is an exploded view of the control knob assembly of FIG. 2;

FIG. 4A is a rear view of the control knob of FIG. 2 illustrating the first configuration;

FIG. 4B is a rear view of the control knob of FIG. 2 illustrating a second configuration;

FIG. 5 is a block diagram of a valve control system in accordance with various embodiments;

FIG. 6 is a block diagram of an example control system for an appliance consistent with some of the embodiments described herein;

FIG. 7 is a flowchart illustrating an example sequence of operations for determining detection of the initiation step and activation;

FIG. 8 is a flowchart illustrating another example sequence of operations for determining detection of the initiation step and activation;

FIG. 9 is a flowchart illustrating an example sequence of operations of the setting of the enable cycle or initiation phase of the control knob;

FIG. 10 is a flowchart illustrating an example sequence of operations of the reading of the enable cycle or initiation phase of the control knob.

### DETAILED DESCRIPTION OF THE INVENTION

Numerous variations and modifications will be apparent to one of ordinary skill in the art, as will become apparent from the description below. Therefore, the invention is not limited to the specific implementations discussed herein.

Referring to drawings, and in accordance with various aspects and embodiments of the invention, a system 10 for at least two-step turn on for an appliance 1 cooking element is described. In various embodiments the appliance 1 in which system 10 is implemented may include a controller 200 integral to appliance 1 that operates appliance 1 and implements various embodiments and aspects of system 10 as described herein.

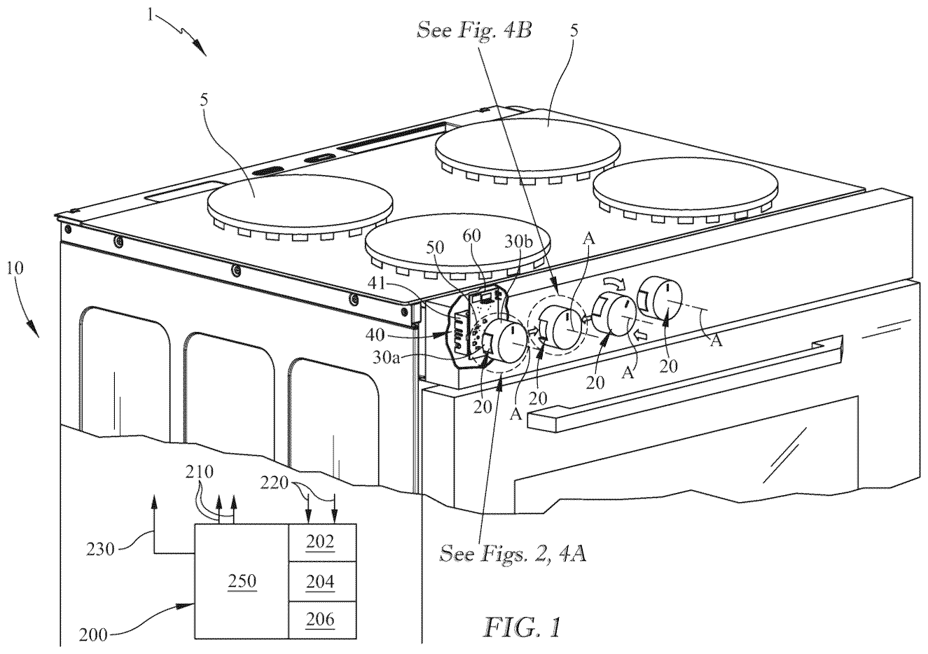

FIG. 1 illustrates an exemplary appliance 1 hardware environment for implementing system 10 for at least a two-step control and operation of a valve 4, igniter 6, and/or cooking element (e.g. burner 5, oven, electric, gas, both). The system 10 may include a controller 200, a processor or processors 202 and concomitant memory 204.

Appliance 1 controller 200 may further comprise a plurality of signal outputs 210 and signal inputs 220 that may be operatively connected to a plurality of appliance 1 components to monitor and direct system 10 operation. Furthermore, in some embodiments controller 200 may include a wireless or hard-wired communications interface 230 that enables controller 200 to communicate with external devices or communications networks such as the internet, that may be integrated into system 10.

Additionally, controller 200 may be equipped with an operator or user interface 250 to provide audible or visual feedback (e.g. alarm, alerts) to a user as well as provide a user the ability to provide instructions or commands to controller 200. Exemplary but non-limiting user interfaces 250 that may be employed include a mouse, keypads, touch-screens, speakers, keyboards, switches and/or touch pads. Any user interface may be employed for use in the invention without departing from the scope thereof. It will be understood that FIG. 1 constitutes, in some respects, an abstraction and that the actual organization of the components of appliance 1 and controller 200 may be more complex than illustrated.

The processor 202 may be any hardware device capable of executing instructions stored in memory 204 or data storage 206 or otherwise processing data. As such, the processor may include a microprocessor, field programmable gate array (FPGA), application-specific integrated circuit (ASIC), or other similar devices.

The memory 204 may include various memories such as, for example L1, L2, or L3 cache or system memory. As such, the memory 204 may include static random access memory (SRAM), dynamic RAM (DRAM), flash memory, read only memory (ROM), or other similar memory devices. It will be apparent that, in embodiments where the processor includes one or more ASICs (or other processing devices) that implement one or more of the functions described herein in hardware, the software described as corresponding to such functionality in other embodiments may be omitted.

The user interface 250 may include one or more devices for enabling communication with a user such as an administrator. For example, the user interface 250 may include a display, a mouse, and a keyboard for receiving user commands. In some embodiments, the user interface 250 may include a command line interface or graphical user interface that may be presented to a remote terminal via the communication interface 230. The user interface 250 and/or controller 200 may be used to send an alert or make an alarm associated with the initiation step (e.g. control knob, magnets, Hall-sensor, board, output outside thresholds of range) not being completed, lack thereof, and/or the inability to activate one or more cooking elements.

The communication interface 230 may include one or more devices for enabling communication with other hardware devices. For example, the communication interface 230 may include a network interface card (NIC) configured to communicate according to the Ethernet protocol. Additionally, the communication interface 230 may implement a TCP/IP stack for communication according to the TCP/IP protocols.

Various alternative or additional hardware or configurations for the communication interface 230 will be apparent.

The storage 206 may include one or more machine-readable storage media such as read-only memory (ROM), random-access memory (RAM), magnetic disk storage media, optical storage media, flash-memory devices, or similar storage media. In various embodiments, the storage 206 may store instructions for execution by the processor 202 or data upon with the processor 202 may operate. For example, the storage 206 may store a base operating system for controlling various basic operations of the hardware. Other instruction sets may also be stored in storage 206 for executing various functions of system 10, in accordance with the embodiments detailed below.

It will be apparent that various information described as stored in the storage 206 may be additionally or alternatively stored in the memory 204. In this respect, the memory 204 may also be considered to constitute a “storage device” and the storage 206 may be considered a “memory.” Various other arrangements will be apparent. Further, the memory 204 and storage 206 may both be considered to be “non-transitory machine-readable media.” As used herein, the term “non-transitory” will be understood to exclude transitory signals but to include all forms of storage, including both volatile and non-volatile memories.

While the controller 200 is shown as including one of each described component, the various components may be duplicated in various embodiments. For example, the processor 202 may include multiple microprocessors that are configured to independently execute the methods described herein or are configured to perform steps or subroutines of the methods described herein such that the multiple processors cooperate to achieve the functionality described herein.

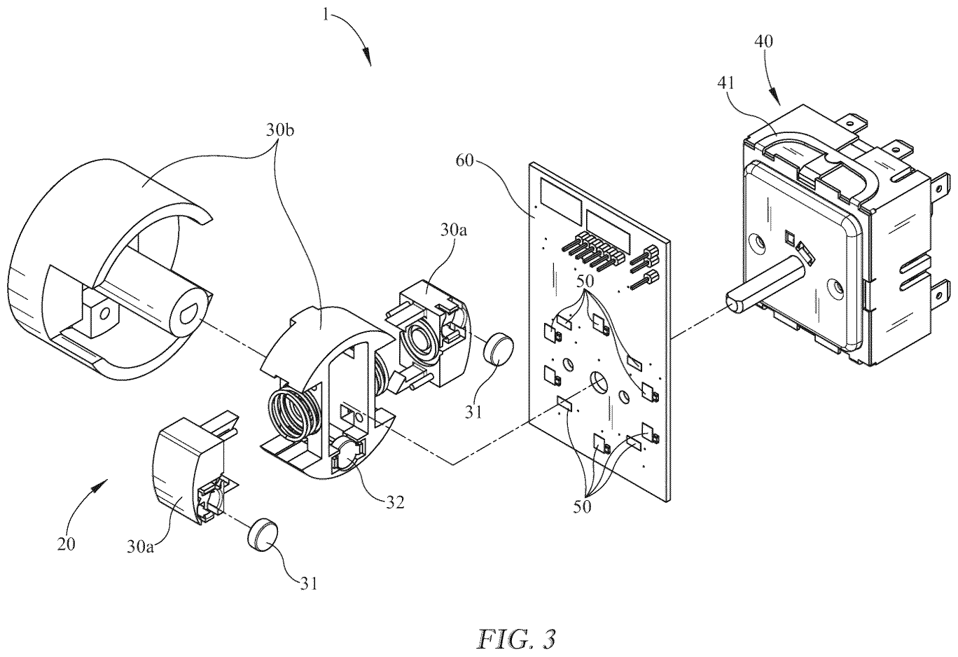

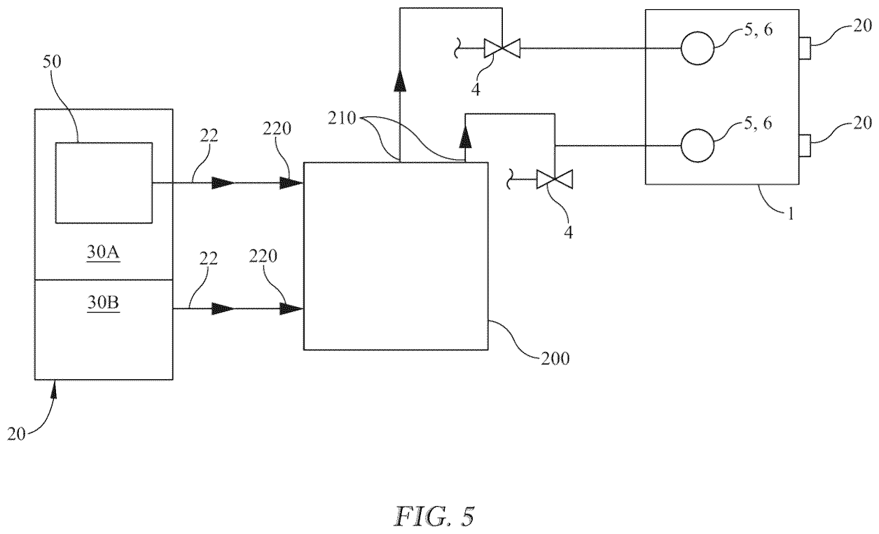

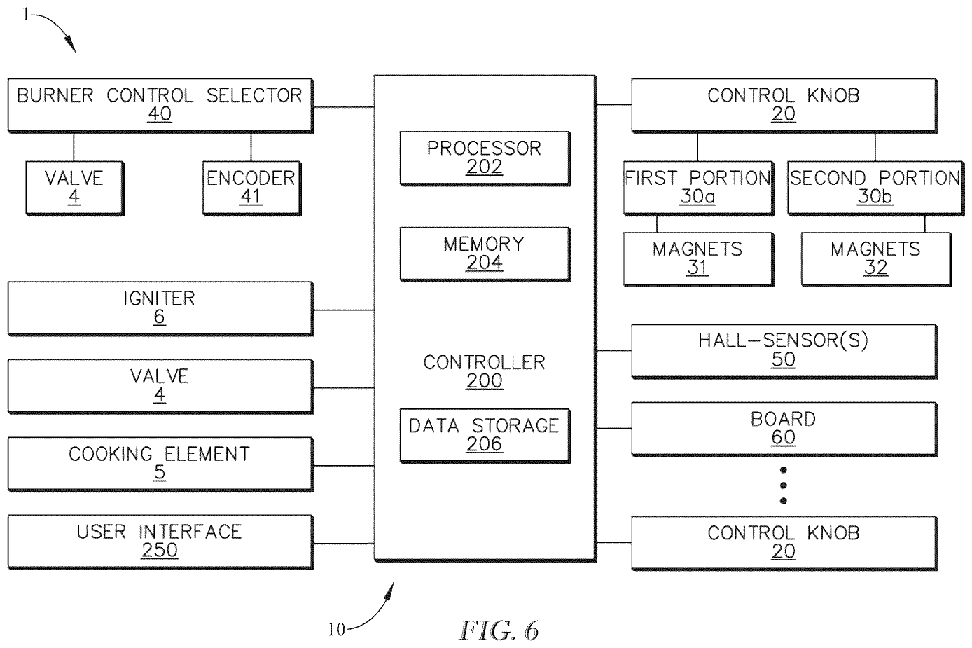

Referring again to FIGS. 1-6, and in accordance with some embodiments, a system 10 for implementing at least a two-step gas valve and/or cooking element turn-on for an appliance 1 includes a plurality of control knobs 20 (alternatively selector knobs 20), that are utilized to initiate operation of one or more cooking elements 5 (e.g. gas, electric, or both), valves 4 (e.g. manual, digital), and/or igniters 6 of appliance 1, or portions thereof. It should be understood that any appliance 1 or other device that utilizes control or selector knobs 20 wherein it would be desirable to implement at least a two-step initiation process may be implemented as part of system 10 without departing from the scope of the invention. For example, a two-step process having the initiation process (e.g. control knob, Hall-sensor, etc.) and subsequent turn. For example, a three-step process having the initiation process (e.g. control knob, Hall-sensor, etc.) and subsequent push and turn.

In one non-limiting exemplary embodiment for purposes of illustration in this specification, appliance 1 may be a conventional gas stove 1, (or equivalently a cooktop and oven combination). Stove 1 may include multiple control knobs 20, for example control knobs 20 to adjust the flow of gas to a plurality of gas valves 4, and thus the heat output of a plurality of cooktop burners 5, as well as a plurality of oven heating/cooking elements or burners 5. In some aspects appliance 1 may include only one control knob that is assigned to individual valves 4 and concomitant burners 5. Other control knobs 20 for adjusting or operating various appliance 1 controls may also be present, but for purposes of explication have been omitted from this example. In one exemplary but non-limiting embodiment that will be used throughout this specification for purposes of explication, the control knobs 20 may be assumed to operate a plurality of cooking elements 5 and/or gas valves 4, for example valves 4 supplying gas cooktop burners/elements 5 and/or gas oven burners/elements 5. In some aspects and embodiments control knobs 20 (e.g. both the first and second portions 30a and 30b) are turned or rotated clockwise to supply additional gas (and therefore heat) to a selected burner 5, and conversely turned counter-clockwise to reduce the amount of gas (and therefore heat) to a selected burner 5. In some aspects and embodiments control knobs 20 (e.g. both the first and second portions 30a and 30b) may be rotated in a first direction to increase the open position of valve 4 and rotated in the opposite direction to reduce the open position of valve 4.

In some implementations, the control knob(s) 20 (e.g. first portion 30a, second portion 30b, both, third portion, etc.) may be mounted to or secured to a burner control selector 40. The burner control selector 40 and/or control knob 20 may supply one or more outputs representative of the energy flow (e.g. heat level, valve position, desired) to one or more cooking elements (e.g. burner, gas, electric, both). The burner control selectors 40 may be, but is not limited to, energy regulators, encoders 41 (e.g. turn only, push and turn), gas valves (e.g. manual, turn only valve, push and turn valve), potentiometers, etc. in operable communication with the system 10, controller 200, valve 4 (e.g. digital), igniter 6, and/or cooking element(s) 5. In the one embodiment shown in the figures, the control knob(s) 20 (e.g. first portion 30a, second portion 30 b, both first and second portions, third portion, fourth portion, etc.) may be mounted to or secured to one or more encoders 41 that supply a plurality of inputs 220 to the controller representative of a desired gas valve 4 position (or burner 5 heat level), whereby controller 200 provides corresponding outputs 210 to control the plurality of gas valves 4. The knob/encoder/actuator 41 may be a turn only operation (e.g. single step) or a push and turn (e.g. two step) to supply the input(s) that includes the initiation process/input/step of the system 10 and/or control knob 20 (e.g. first portion 30a). For example, creating the two-step activation or three-step activation, respectively, of the cooking elements and/or appliance, or portions thereof (e.g. valve, igniter). Although not shown, in some embodiments, the control knob 20, board, and/or Hall-sensor(s) may be mounted directly to a gas valve 4 (e.g. turn only, push and turn) as the burner control selector 40 rather than indirectly operating a valve.

In accordance with some aspects of the disclosure system 10 (e.g. button(s) 30a) provides a plurality of at least two-step methods and concomitant apparatus for implementing at least a two-step turn on for a gas valve 4 and/or cooking element(s) 5 (e.g. gas, electric, both). In one exemplary embodiment appliance 1 includes at least one control knob 20 for setting a desired valve 4 and/or encoder 41 position, or alternatively cooking element burner 5 power/energy level. Throughout the specification burner control selector/encoder/gas valve 4 position and cooking element/burner 5 power level and/or heat level will be referred to interchangeably. It should be understood that the position of a specified gas valve 4 and/or burner control selector 40 will dictate the power level and/or heat level of that burner 5 (e.g. gas, electric, both).

Control selectors or knobs 20 (e.g. both the first and second portions) and/or burner control selector 40 may include an output 22 that is representative of valve 4 position or burner power level (e.g. gas, electric, both), operatively coupled to an input of 220 of controller 200. The burner control selector 40 may have an output representation of energy flow (e.g. gas, electric, both) to the one or more cooking elements 5 (e.g. gas, electric, both). Controller 200 will then supply, when conditions precedent are satisfied as discussed herein below, an output 210 representative of valve 4 position to valve 4 and/or energy flow to gas/electric burner, and/or an ignition output 210 to a valve igniter 6 to ignite valve 4 at a desired power level.

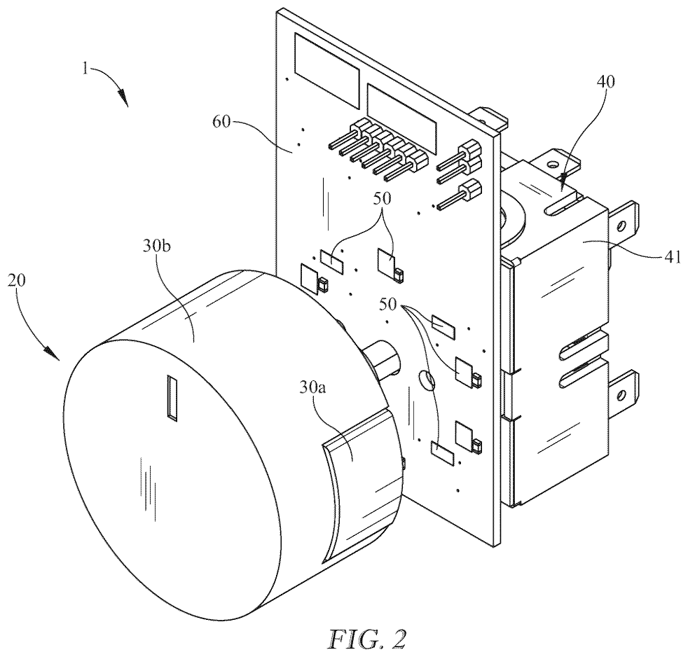

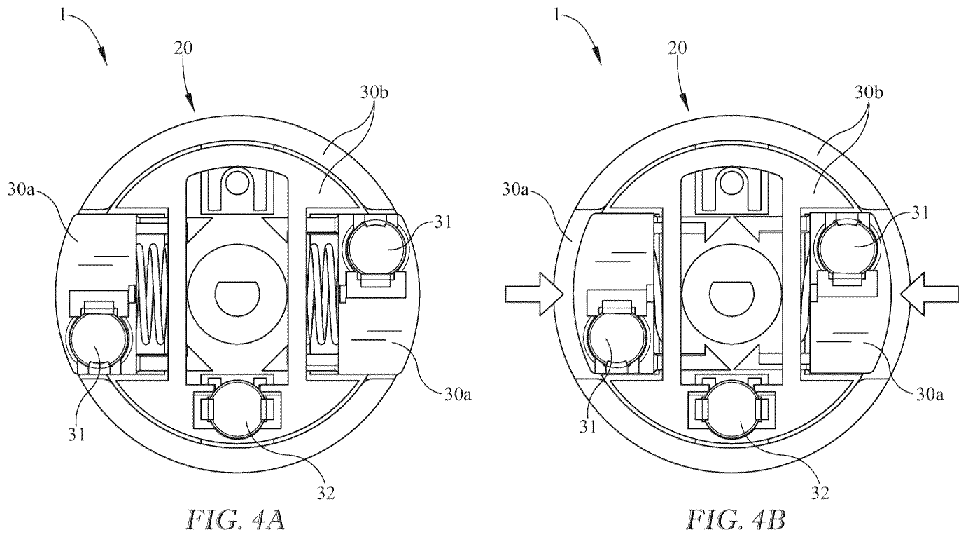

System 10, appliance 1, and/or control knob 20 may further include a movable control knob member, portion, or element 30a (e.g. with magnet(s), first portion(s)) that must be touched, selected, depressed, displaced, or otherwise contacted or chosen by a user to activate/initiate a gas valve 4, igniter 6, and/or cooking element 5 (e.g. gas, electric, both) assigned to the control knob 20. The control knob 20 may include one or more first portions 30a and one or more second portions 30b. In some exemplary embodiments and aspects one or more control knob first portions 30a include one or more magnets 31. The magnets 31 (e.g. first) may be movable with the first portions 30a. In some embodiments as shown, the second portion 30b of the control knob 20 may include one or magnets 32 (e.g. second), moveable with the second portion 30b. The one or more first portions 30a and/or magnet(s) 31 are displaceable or moveable relative to the one or more second portions 30b (e.g. magnet(s), if used), Hall-sensor(s) 50, and/or electronic board 60. The one or more first portions 30a and magnets 31 may move or be positioned by the user relative to the second portion(s) 30b, magnet(s) 32, Hall-sensors 50, board 60, and/or burner control selector 40 between a first configuration and a second configuration different from the first configuration. One embodiment of the first configuration is shown in FIGS. 2 and 4A. One embodiment of the second configuration is shown in FIG. 4B. In the one embodiment shown, the one or more first portions 30a are opposing members, that are squeezed radially inward relative to the second portion 30b. The first portions may include a receptacle containing the magnets 31. The first portion may slide between configurations within a slot within the second portion. The first portion(s) 30a may be opposing biased members (e.g. buttons) biased radially outwards, towards the outer periphery of the control knob 20. One or more springs (e.g. compression) may bias the first portions 30a away from the second configuration towards the first configuration. Although the first portion(s) 30a (e.g. with magnet(s) 31) may be displaced in the radial direction, other directions are contemplated for the user to move the safety feature or member/portion(s). For example, the first portion may be rotated in one or more directions (e.g. in opposite rotational direction of the control knob first and second portions operation to activate the burner). Another example, the first portion may be axially moved in one or more directions relative to the control knob second portion (e.g. towards or away from the actuator or burner control selector).

In some implementations, the system 10, appliance 1, control knob 20, and/or burner control selector 40 may include one or more Hall-sensors 50 and/or electronic board 60. The electronic board 60, if used, may include or position one or more Hall-sensors 50 adjacent the one or more control knobs 20, board 60, and/or burner control selector 40, or portions thereof. The Hall-sensor(s) 50 may be in communication (e.g. output, input) with the controller 200 and/or board 60. In the first configuration the one or more Hall-sensors 50 is configured to output a first output 22 (e.g. voltage, voltage change) and when in the second configuration a second output 22 (e.g. voltage, voltage change) different from the first output. Changing the configuration/position of the portions 30a/magnets 31 relative to the Hall-sensors 50/board 60 may change the output voltage. When the controller 200 receives the first output 22 from the Hall-sensor(s) 50/board 60, when the one or more first portions 30a with the one or magnets 31 are in the first configuration, the controller 200 is configured to not allow activation of the one or more cooking elements 5 and/or one or more portions of the appliance.

When the controller 200 receives the second output (e.g. voltage, voltage change) from the Hall-sensor(s) 50/board 60, when the one or more first portions 30a with the one or more magnets 31 are in the second configuration, the controller 200 is configured to allow activation of the one or more cooking elements 5 and/or one or more portions of the appliance. Repositioning to the second configuration or voltage change output may be configured to represent the initiation/first step of subsequent step(s) (e.g. second, third, fourth, etc.) to allow activation of the one or more portions of the appliance to energize the cooking elements(e.g. gas, electric, both), rather than not allowing activation (e.g. lock out, off mode) when no change out of the first configuration. In some embodiments, the subsequent step(s) required for energization after the displacement to the second configuration may need to be completed within a predetermined timeframe, or a lock out may occur such that no activation may be completed and/or another displacement from the first configuration to the second configuration may need to occur.

In yet further aspects and embodiments, and as best depicted in FIGS. 2-4B, control knobs 20 may include first portion(s) or button(s) 30a for the safety feature or initial step. The first portion 30a may be disposed in an outer periphery of knob 20 that may incorporate aspects of access control for an appliance 1. The first portion 30a may be positioned at a larger radius from the axis A of the knob when in the first configuration than when in the second configuration. When in the second configuration, the first member/portion/switch 30a, Hall-sensor(s) 50, and/or board 60 may include an output 22 (e.g. voltage, voltage change) operatively coupled to an input 220 to controller 200 to indicate conditions precedent are satisfied or selection by a user. In one exemplary embodiment, a user may initiate valve 4 and/or cooking element 5 operation and/or ignition by touching or selecting the control knob first portion or button 30a on a specific control knob 20 (e.g. from the first configuration to the second configuration) and subsequently pushing/rotating the burner control selector 40 and/or control knob 20 to a desired burner power level. Alternatively, simultaneously selecting the first portion 30a (e.g. from the first configuration to the second configuration) and pushing/rotating the knob 20(e.g. both the first and second portions) and/or burner control selector 40 may operate the desired burner power. In an exemplary embodiment where appliance 1 is a stove, oven, or cooktop, after initiation of the control knob first portion 30a to the second configuration the selected ignitor 6 is then provided an output 210 from controller 200 and valve 4 is provided an output 210 representative of desired valve 4 position, thereby igniting and setting the burner heat level. In some implementations, if the first member 30a and/or Hall-sensor(s) output 22 is not satisfied the cooking operation (e.g. valve is not opened) may not be activated.

In accordance with some embodiments, when the magnets 31 and first portion 30a is displaced between the first configuration to the second configuration an output (e.g. voltage, voltage change) of the Hall-sensor(s)/board 60 is communicated with the controller 200. The output 22 (e.g. voltage, voltage change) of the Hall-sensor(s) is representative of a permission to activate the cooking element 5, burner control selector 40, and/or one or more portions (e.g. valve, igniter) of the appliance. In some implementations, a first input 220(e.g. voltage, voltage change, no change) received by the controller 200 operatively coupled to the output 22 (e.g. first) of the one or more Hall-sensors 50 may be representative of the first configuration of the one or more magnets 31 of the first portion 30a of the control knob 20, wherein no permission to operate/activate the burner control selector, cooking element, igniter, and/or valve the one or more cooking elements receiving the output of the burner control selector. In some implementations, a second input 220 (e.g. voltage, voltage change) received by the controller 200 operatively coupled to the output 22 of the one or more Hall-sensors 50 may be representative of the second configuration of the one or more magnets 31 of the first portion 30a of the control knob 20, wherein the burner control selector 40, cooking element 5, igniter 6, and/or valve 4 is operated/activated only after receiving the output of the burner control selector/knob/Hall-sensor(s). It should be understood that in some embodiments, the second output may be within a predetermined range of voltage or voltage change (e.g. top threshold, bottom threshold, both). For example, an output 22 (e.g. second) outside the range may indicate an unintentional activation or Hall-sensor error. After the initiation step or output 22 of the one or more Hall-sensors is representative of the second configuration and permission to activate, the operation or output of the burner control selector 40 may be a two-step or more than one step activation (e.g. push and turn) of the cooking element(s), valve, and/or portions of the appliance. In various embodiments, after the initiation step or output 22 of the one or more Hall-sensors 50 is representative of the second configuration and permission to activate, the operation or output of the burner control selector may be a single-step activation (e.g. turn) of the cooking element(s), valve, and/or portions of the appliance.

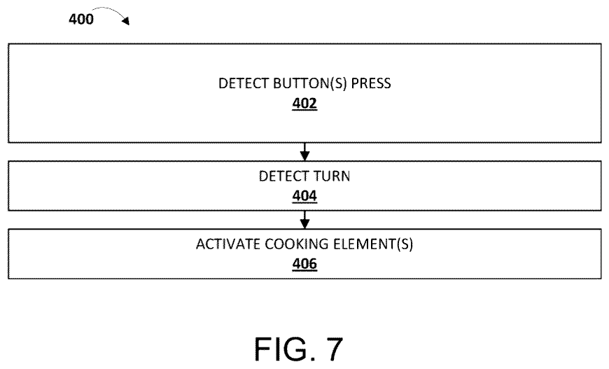

An example process for performing the initiation step/process consistent with the invention is illustrated at 400 in FIG. 7. In order to activate the cooking elements directly or indirectly, the button or first portion 30a is first detected in block 402 to be pressed/squeezed. When the button(s) is pressed the variable from the Hall-sensor(s) is received by the controller. With the button released and biased, if used, towards first configuration, the subsequent step(s) or rotation of the knob is detected in block 404.

The cooking elements and/or one or more portions of the appliance are activated in block 406.

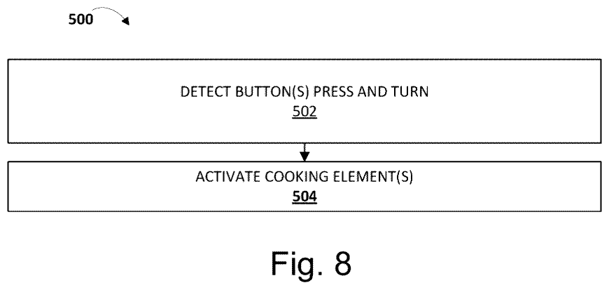

Now turning to FIG. 8, it may also be desirable to use the initiation step/process at 500 to hold the depression of the button/first portion(s) while turning the knob 20 to activate the cooking elements. Both the pressing of the button(s) or first portion(s) 30a and turning of the knob 20 (e.g. both first and second positions) are detected in block 502. The cooking elements and/or one or more portions of the appliance are activated in block 504. This two-step operation may be described as a squeeze/press and turn operation. In this one embodiment if the button(s) 30a were released, the turn of the knob would not be operable to activate the cooking elements.

In accordance with some embodiments, the control knob 20 and/or first portion 30a/magnets 31 must be first moved/displaced from the first configuration to the second configuration when the knob is in a single rotational position and/or home position. For example, the second input 220 to the controller or output 22 of the Hall-sensor(s) occurs only in the home position of the control knob to represent intentional activation. For example, the second input 220 to the controller or output 22 of the Hall-sensor(s) occurs out of the home position of the control knob represents unintentional activation.

Unintentional activation may result in a continued lock out of operating the cooking element and/or portion(s) of the appliance. Alternatively, in some embodiments, a home position is not used.

In some implementations, an alarm or alert to the user may correspond to unintentional activation of the control knob 20, Hall-sensor(s) 50, and/or first portion 30a displacement. For example, the controller may receive an input (e.g. first, second) outside the range of predetermined voltages or output of the Hall-sensor(s) that correspond to not allowing the activation of the one or more cooking elements and/or portions of the appliance resulting in an alarm/alert. Further for example, an alert, if used, may be presented when no permission to operate the one or more cooking elements receiving the output of the burner control selector when a first output 22 representative of the first configuration of the one or more magnets of the first portion of the control knob and/or another or second output 22 representative of the second configuration of the one or more magnets of the first portion of the control knob is outside (e.g. lower, above, or both) the range of predetermined outputs/voltages. The alarm or alert may be, but is not limited to, audio, visual, or both from the appliance, or portions thereof, or another connected device (e.g. cell, interface). Further for example, if a home position is required and an output representative of the second configuration in a position not in the home position and/or an output outside the range is received an alarm may be communicated to the user.

In accordance with additional aspects and embodiments of the invention the system or safety feature of the control knob 20 may be utilized prior to selecting or activating a power/energy level (e.g. gas, electric, or both) for the burner or cooking elements (e.g. gas, electric, or both). In this embodiment, displacement of the control knob first portion having the one or more magnets relative to the remaining portion of the control knob (e.g. second portion) and the Hall-sensor(s)/board creates an output voltage (e.g. change, first). The Hall-sensor(s) 50 output 22 (e.g. voltage, change in voltage) may be received by the controller/appliance, or portions thereof. The cooking element(s) may be activated when the output (e.g. first, voltage) of the Hall-sensor(s) received by the controller is within a predetermined range. The cooking element(s) may not be activated when the output 22 (e.g. first, voltage) and/or input 220 received by the controller is outside the predetermined range. An alarm or alert, if used, may be used to identify to the user that the cooking element(s) or activation cannot be completed and/or outside the predetermined range (e.g. above, below). The burner control selector 40 may output representative of the energy flow to the cooking elements. After the safety feature or detection of the button 30a pressed is utilized, the burner control selector may include at least another step (e.g. single-step, two-step, etc.) to activate or output energy flow to the cooking elements or portions of the appliance. The burner control selector 40 may be inoperable when the output of the Hall-sensor(s) received by the controller is outside the predetermined range (e.g. voltage, voltage change). The operation of the burner control selector may be only after the output 22 of the Hall-sensor(s) 50 is within the predetermined range.

Moreover, the herein-described techniques may be used in connection with various cooking appliance configurations. Implementation of the herein-described techniques within gas/electric top burner(s), oven burner, broil burner, gas/electric range, gas/electric slide-in oven, freestanding oven, gas/electric cooktop, gas/electric countertop range, etc. would be well within the abilities of one of ordinary skill in the art having the benefit of the instant disclosure, so the embodiments, are not limited to the freestanding oven implementations using a manual/electric gas valve, switch, or actuator (e.g. push and turn, turn, slide). Although the actuator/encoder 41/selector 40 may be a push and turn as shown in the embodiments, the actuator may only require rotation or another type of operation(s) and still be within the scope of the invention. Moreover, the herein-described techniques may be used in manual and/or electronic controls/valves/actuators/switches or other applications with controls such as, but is not limited to, gas/electric furnaces, gas/electric water heaters, gas/electric fireplaces/logs, and gas/electric space heaters.

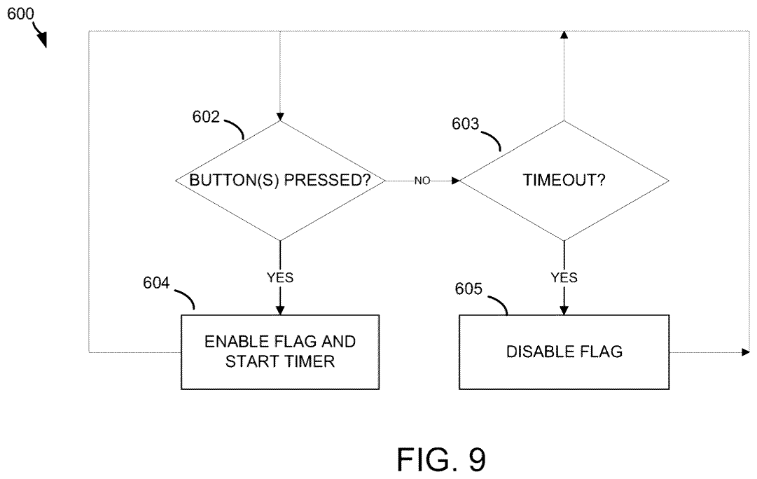

Now turning to FIG. 9, and with continuing reference to FIGS. 1-8, one sequence 600 of setting the enable variable for performing the initiation step for operating the one or more cooking elements. Block 602 may determine the button(s)/magnet(s) pressed based upon a variety of outputs from the Hall-sensor(s). A loop in blocks 603-605 may control the enable/disable of the variable/flag of the control knob/system and monitors the enable/disable of the variable/flag, for example, duration (block 603). If the buttons are not pressed and not within a duration the disable variable is received (block 605).

When disabled, the cooking elements and/or portion(s) of the appliance may not be activated. If and when the buttons/portion(s) 30a of the control knob are pressed, the enable variable/flag and duration/timer is monitored or received (block 604).

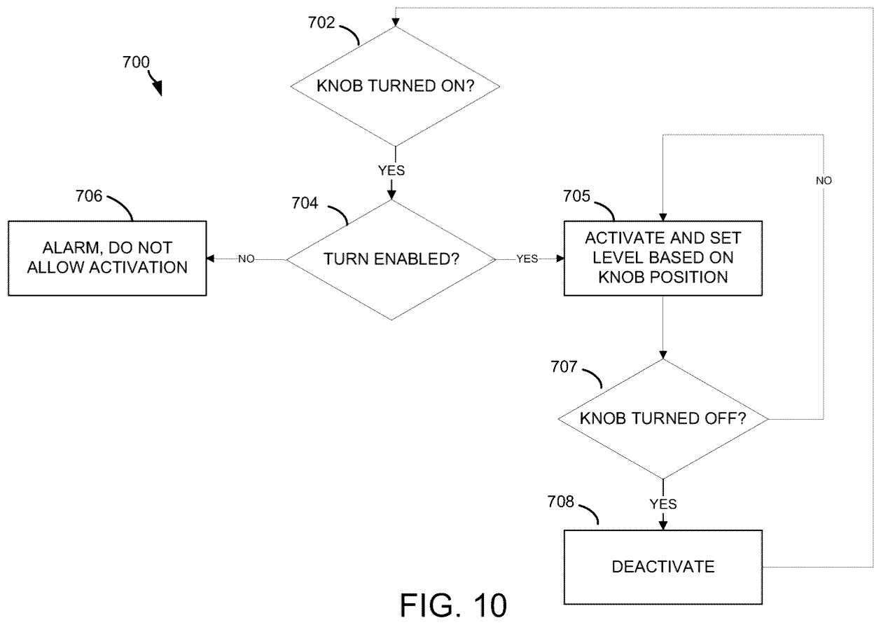

FIG. 10 illustrates an example sequence 700 of reading the enable flag/variable for performing the one or more steps of activation of the cooking elements/appliance, or portions thereof. Once the knob 20 is turned/operated (block 702), block 704 may determine the enable flag criteria, e.g., pressing the button/portion(s) 30a. If the initiation of the control knob button/first portion is not met (e.g. the knob is turned on before the button is pressed, the control knob is turned on too long after a duration of time after the button is pressed, timed out), the lack of enablement may pass to block 706 to end the cycle. Not allowing activation and/or ending of the cycle (block 706) may include an indicator, alarm, message, text, visual, and/or audio, or the like to make the user aware of the end of cycle. If the turn is enabled or enablement criteria (block 704) is met, the cooking element or one or more portions of the appliance may be activated and/or the power level set based on the control knob position (block 705). The knob position may be monitored (blocks 707, 708, 705). If and when the knob is turned off (block 707), the cooking elements may be deactivated (block 708) to end the cycle and loop back to block 702.

While a variety of inventive embodiments have been described and illustrated herein, those of ordinary skill in the art will understand that a variety of other methods, systems, and/or structures for performing the function and/or obtaining the results, and/or one or more of the advantages described herein are possible, and further understand that each of such variations and/or modifications is within the scope of the inventive embodiments described herein. Those skilled in the art will understand that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03. It should be understood that certain expressions and reference signs used in the claims pursuant to Rule 6.2(b) of the Patent Cooperation Treaty (“PCT”) do not limit the scope.

1. A cooking appliance comprising:
one or more cooking elements;
a control knob operating the one or more cooking elements and having one or more first portions moveable relative to a second portion of the control knob between a first configuration and a second configuration different from the first configuration, the one or more first portions include one or more magnets;
an electronic board having one or more Hall-sensors;
a controller in communication with the one or more Hall-sensors, wherein the one or more Hall-sensors is configured to output a first output when in the first configuration and a second output when in the second configuration different from the first output; and
wherein when the controller receives the first output when the one or more first portions with the one or magnets are in the first configuration the controller is configured to not allow activation of the one or more cooking elements and when the controller receives the second output when the one or more first portions with the one or more magnets are in the second configuration the controller is configured to allow activation of the one or more cooking elements, and wherein the second output is within a predetermined range of voltage change.

2. The cooking appliance of claim 1 wherein the controller receiving the first output sends an alarm or alert corresponding to not allowing activation of the one or more cooking elements.

3. The cooking appliance of claim 1 wherein the control knob includes an output representation of a desired energy flow to the one or more cooking elements.

4. (canceled)

5. The cooking appliance of claim 1 wherein the control knob includes a home position, and wherein the second output occurs only in the home position of the control knob.

6. The cooking appliance of claim 1 wherein the one or more first portions of the control knob include opposing biased members, wherein each one of the opposing biased members include at least one of the one or more magnets.

7. A system for initiation of activation of one or more cooking elements comprising:
a burner control selector having an output representation of energy flow to the one or more cooking elements;
a first portion of at least one control knob having one or more magnets moveable relative to a second portion of the at least one control knob;
an electronic board having one or more Hall-sensors, the one or more Hall-sensors having an output representative of a permission to activate the burner control selector;
a controller having a plurality of inputs and outputs for receiving and providing electrical signals;
a first input operatively coupled to the output of the one or more Hall-sensors representative of a first configuration of the one or more magnets of the first portion of the at least one control knob and wherein no permission to operate the one or more cooking elements receiving the output of the burner control selector; and
a second input operatively coupled to the output of the one or more Hall-sensors representative of a second configuration of the one or more magnets of the first portion of the at least one control knob wherein the one or more cooking elements is operated only after receiving the output of the burner control selector; and
a first output representative of the first configuration of the one or more magnets of the first portion of the at least one control knob wherein an alert is presented when no permission to operate the one or more cooking elements receiving the output of the burner control selector.

8. The system of claim 7 wherein the second input must be received by the controller when the at least one control knob is in single rotational position.

9. The system of claim 7 wherein the one or more cooking elements is at least one of electric and/or gas.

10. The system of claim 7 wherein the output of the burner control selector is a two-step activation of the one or more cooking elements.

11. The system of claim 7 wherein the output of the burner control selector is a single-step activation of the one or more cooking elements.

12. (canceled)

13. The system of claim 7 wherein the first portion of the at least one control knob includes two opposing biased members.

14. A method for controlling operation of one or more cooking elements with a safety feature of a control knob, the method comprising:
providing at least one control knob operably connected to one or more cooking elements of a cooking appliance, wherein the at least one control knob includes a first portion moveable relative to a second portion of the control knob between a first configuration and a second configuration different from the first configuration, the one or more first portions include one or more magnets;
providing an electronic board having one or more Hall-sensors adjacent the at least one control knob, wherein the one or more Hall-sensors output a voltage received by a controller, and wherein the one or more Hall-sensors is configured to output a first output when in the first configuration and a second output when in the second configuration different from the first output; and
activating the one or more cooking elements when the first second output of the second configuration received by the controller is within a predetermined range of voltage change and not activating the one or more cooking elements when the first output of the first configuration is received by the controller.

15. The method of claim 14 further comprising alerting the user that the one or more cooking elements cannot be activated or when the first output received by the controller is outside the predetermined range of voltage change.

16. The method of claim 14 further comprising a burner control selector having an output representative of an energy flow to the one or more cooking elements.

17. The method of claim 16 wherein the burner control selector includes a two-step activation or a single-step activation.

18. The method of claim 16 wherein the burner control selector is inoperable when the second output received by the controller is outside the predetermined range of voltage change.

19. The method of claim 16 wherein the step of activating the one or more cooking elements includes operation of the burner control selector only after the second output received by the controller is within the predetermined range of voltage change.

20. The method of claim 14 wherein the one or more cooking elements is at least one of gas and/or electric.

21. A cooking appliance comprising:
one or more cooking elements;
a control knob operating the one or more cooking elements and having one or more first portions moveable relative to a second portion of the control knob between a first configuration and a second configuration different from the first configuration, the one or more first portions include one or more magnets;
an electronic board having one or more Hall-sensors;
a controller in communication with the one or more Hall-sensors, wherein the one or more Hall-sensors is configured to output a first output when in the first configuration and a second output when in the second configuration different from the first output;
wherein when the controller receives the first output when the one or more first portions with the one or magnets are in the first configuration the controller is configured to not allow activation of the one or more cooking elements and when the controller receives the second output when the one or more first portions with the one or more magnets are in the second configuration the controller is configured to allow activation of the one or more cooking elements; and
wherein the control knob includes a home position, and wherein the second output occurs only in the home position of the control knob.

22. The cooking appliance of claim 21 wherein the controller receiving the first output sends an alarm or alert corresponding to not allowing activation of the one or more cooking elements.
